(19) United States
(12) Patent Application Publication
(10) Pub. No.: US 2006/0035712 A1
(43) Pub. Date: Feb. 16, 2006

(54) System and method for placing a wager on events

(75) Inventors: Tim Eastman, Encino, CA (US); Joseph Hasson, Encino, CA (US); Jeffrey R. Horowitz, Sherman Oaks, CA (US); Armen Jamkotchian, Glendale, CA (US); David Marshall, Los Angeles, CA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Youbet.com, Inc., Woodland Hills, CA (US)

(21) Appl. No.: 11/125,685

(22) Filed: May 10, 2005

Related U.S. Application Data
(60) Provisional application No. 60/600,973, filed on Aug. 12, 2004.
(60) Provisional application No. 60/601,273, filed on Aug. 13, 2004.

(51) Int. Cl. G06F 19/00

(52) U.S. Cl. 463/42

(57) ABSTRACT

A system and method for placing a wager on events is disclosed. The system includes a web server connected to the Internet, a database in communication with the web server storing codes corresponding to at least one criterion associated with an event for an interactive voice response (IVR) system and generating a string of codes corresponding to a wager, and a graphical user interface. The graphical user interface is accessible from a client workstation separate from the web server and communicates with the web server to establish the wager. The graphical user interface initiates a call from the client workstation to transmit the string of code to the IVR system using voice-over internet protocols.

### CROSS REFERENCE TO RELATED APPLICATION

This application claims the benefit of U.S. Provisional Patent Application Ser. Nos. 60/600,973 and 60/601,273 filed Aug. 12, 2004 and Aug. 13, 2004, respectively.

### BACKGROUND OF THE INVENTION

1. Field of the Invention

The subject invention relates to a system and method for placing a wager on events, and more specifically to a system and method for placing a wager on events using the Internet.

2. Description of the Related Art

Wagering on events, such as horse races, is a large and growing industry in many parts of the world. Various types of betting products or systems are available for various types of sporting events. For example, typical horse racing bets allow bettors to wager on a single horse or on several horses in a particular race or series of races. For instance, a bettor can bet on a particular horse to finish first (win), finish in the top two (place), or finish in the top three (show). A bettor may also make exotic bets with multiple horses, such as an exacta bet (covering the top two horses in order) or a trifecta bet (covering the top three horses in order). In addition, a bettor may bet on a series of races, such as the daily double (winners of two consecutive races), the pick-three (winners of three consecutive races), and the pick-six (winners of six consecutive races).

Various related art systems and methods are known for placing the wagers on such events. These related art systems and methods are used with numerous types of betting, gambling, gaming, games of chance, or wagering (collectively “wagering” hereinafter). For example, wagering may be a pari-mutuel type or may be a fixed-odds type. A pari-mutuel wager pools money from multiple bettors. After the wager, winning bettors share the total money in the pool minus a commission amount, such that bettors compete among themselves for portions of a common pool of funds. Some pari-mutuel wagering includes horseracing, dog racing, jai alai, and other sporting events. Fixed-odds wagering may be against odds offered by a bookmaker, an individual, or on a bet exchange. Sometimes fixed-odds wagering determines expected odds at the time of the placement of the wager.

Traditionally, wagers were placed in person at the event, such as at the track. However, it may be inconvenient to attend events in person and not all bettors have sufficient time to visit tracks as often as they would like and some have difficulties in obtaining suitable transportation to the track. Off-track betting (OTB) establishments have been developed to allow bettors to place bets without having to attend the events in person. These OTB establishments generally have multiple locations conveniently located for bettors. However, bettors must still travel to the OTB establishments. Some OTB establishments do not require the bettor to come to the off-track betting establishment in person. These OTB establishments provide live operators or agents for receiving calls from the bettor and for placing the wagers. However, the better still must interface with live operators and agents, which prevents some people from betting on events.

Telephone wagering systems, such as interactive voice response (IVR) systems, exist to allow bets to be placed using the plain-old telephone service (POTS). A user obtains wagering data, such as the races scheduled at tracks and entries in each race and then uses a table to identify the proper telephone wagering code, or IVR code that may be used to place the wager from the telephone. With IVR systems, the user does not have to speak to a live operator. These telephone wagering systems require complex codes to be generated from various tables and different IVR systems use different codes. Further, the user must calculate a cost for the wagers, which may be complex depending upon the wager.

Other systems have developed Internet-based graphical user interfaces (GUI) to allow the user to wager without having to place a call. The user accesses the GUI from the Internet and establishes the bet. The user then submits the bet over the Internet. The system generally includes a web server connected to the Internet that hosts the GUI. Once the bet is received at the web server, the web server transmits the bet to the IVR system.

One such system and method is illustrated in U.S. Patent Application Publication No. 2002/0077712 A1 to Safaei et al. The system includes a web server connected to the Internet and in communication with a telephone wagering system and also includes user terminals connected to the Internet. The user accesses the web server via the Internet and establishes a wager. The system includes a code module having codes corresponding to possible wagers to be placed. The system then determines the code for the wager and the wager is placed from the web server to the telephone wagering system. Alternatively, the user may enter the code manually by placing a call using the POTS.

Various jurisdictions that allow wagering on events do not allow wagers to be placed over the Internet. Said another way, it may be illegal to place wagers over the Internet. Therefore, users must either travel to the location of the event or travel to the OTB establishment. Alternatively, these jurisdictions generally allow wagers to be placed over the telephone. With the increasing use of the Internet, users do not want to have to place the telephone call themselves because the Internet already allows them to be able to view the event information.

These related art systems and methods are characterized by one or more inadequacies. Therefore, it would be advantageous to provide a system and method that does not require the user to visit the event location or the OTB establishment from those jurisdictions where it is illegal to place wagers over the Internet.

### SUMMARY OF THE INVENTION AND ADVANTAGES

The subject invention provides a system and a method for placing a wager on events. The system includes a web server connected to the Internet, a database in communication with the web server, and a graphical user interface. The database stores codes corresponding to at least one criterion associated with an event for an interactive voice response system and generates a string of codes corresponding to a wager. The graphical user interface is accessible from a client workstation separate from the web server and communicates with the web server to establish the wager. The graphical user interface initiates a call from the client workstation to transmit the string of code to the interactive voice response system using voice-over internet protocols.

The method of the subject invention compiles the database, provides the web server accessible over the Internet in communication with the database, provides the graphical user interface, and generates the string of code representing the wager. The method further transmits the string of code from the web server to the client workstation and initiates the call from the client workstation to the interactive voice response system over the Internet to place the wager for the event.

The system and method of the subject invention overcomes the inadequacies that characterize the related art systems and methods. Specifically, the subject invention allows the user to access a graphical user interface over the Internet and establish the wager to be placed on the event and place the bet through the graphical user interface. The subject invention places the wager by placing a call from the client workstation, which allows the user to place wagers in those jurisdictions where wagers cannot be placed over the Internet. To the user, the subject invention appears as if the wager is being placed over the Internet; however, the client workstation is placing the bet, thereby making it easier for the user to place wagers.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a system for placing a wager on events;

FIG. 2 is a representation of a database having codes corresponding to criteria for placing a wager on events;

FIG. 3A is a representation of a graphical user interface that communicates with a web server for allowing a user to place a wager for an event;

FIGS. 3B and 3C are representation of the graphical user interface to select criteria to establish the wager;

FIG. 4 is a representation of a graphical user interface that communicates with a web server for allowing a user to place a wager for multiple events; and

FIG. 5 is a flowchart of a method for placing a wager on events according to the subject invention.

### DETAILED DESCRIPTION OF THE INVENTION

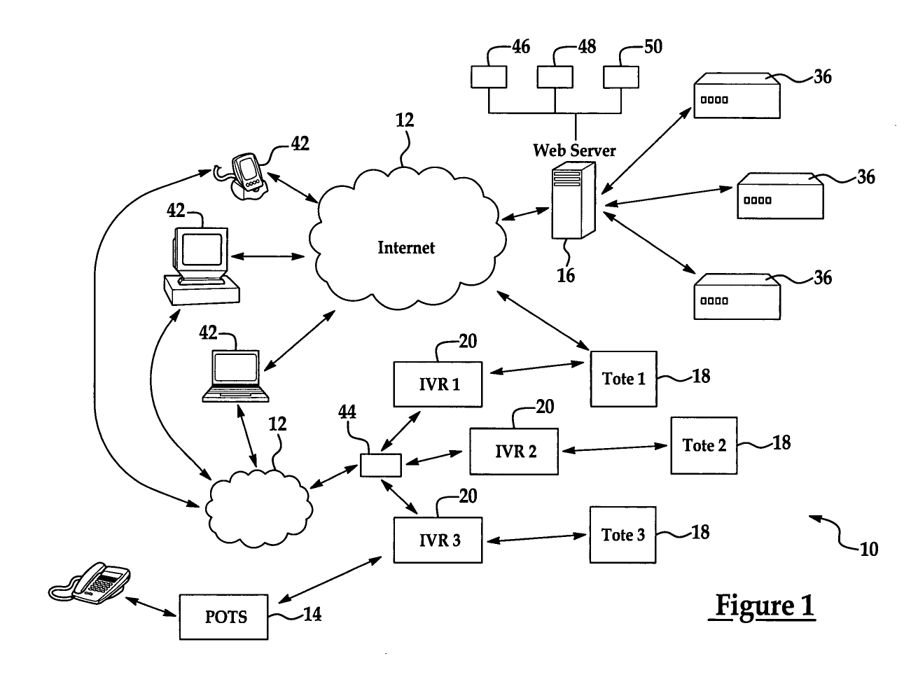

Referring to the Figures, wherein like numerals indicate corresponding parts throughout the several views, a system for placing a wager on events is shown generally at 10 in FIG. 1. The subject invention further provides a method of placing the wager by a user utilizing a computer network, such as the Internet 12. The computer network may also include intranets. Preferably, the subject invention does not rely on a plain-old telephone system 14 (POTS) for placing the wager. However, the POTS 14 may be used for additional or other features of the subject invention, as will be described below. Illustrative events that the system 10 and the method are particularly useful for placing wagers on include horse racing, dog racing, automobile racing, sporting events, game shows, and casino events. The subjection invention is described herein primarily in the context of wagering on races (e.g., horse races) for specificity and clarity, without being limited thereto.

The system 10 includes a web server 16 connected to the Internet 12. The web server 16 may be in communication with an interactive voice response (IVR) system 20 and a totalizator 18. The IVR system 20 is responsive to codes corresponding to at least one criterion 22 associated with the event. The criteria 22 associated with the event may include event type 24, event location and venue 26, event number 28, participant number 30, type of wager 32, number of wagers, and amount of wager 34. For example, the event type 24 may be a horse race and the location 26 may be at Gulfstream Race Track. The event number 28 may correspond to race number “1” and the participant number 30 may correspond to horse number “4”. The type of wager 32 depends upon the event type 24. For a race, the type of wagers may include win, place, show, or exotic bets. The user may also desire to place multiple bets on the same event.

The web server 16 may be in communication with a plurality of IVR systems 20 having codes different from one another. Further, each IVR system 20 may include different events from one another, such that one IVR system 20 has horse racing, while another IVR system 20 has casino events. The subject invention is capable of interacting with multiple third party IVR systems 20 as well as IVR systems 20 specifically operating with the subject invention.

It is to be appreciated by those skilled in the art that the IVR systems 20 are well known and are typically hosted by third parties. The codes used by the IVR system 20 may be generated by the totalizator 18 or vice versa. Alternatively, if the IVR system 20 and the totalizator 18 are connected with the system 10 of the subject invention, the web server 16 may generate the codes to be used by both the IVR system 20 and the totalizator 18. The IVR system 20 generally presents menu options to the user in the form of audio prompts (e.g., “press 1 to select a $2 wager amount,” etc.). The IVR system 20 then requires corresponding codes to be entered. The related art telephone wagering systems 10 required the user to press buttons on a touch tone telephone or speak the selection. The subject invention overcomes such a requirement.

A single IVR system 20 may be in communication with a single totalizator 18 or a plurality of totalizators 18. Likewise, a single totalizator 18 may be in communication with a plurality of IVR systems 20. Further, totalizators 18 may be associated with individual racetracks or groups of racetracks. Totalizators 18 are well known by those skilled in the art and include computer systems 10 that handle wagers to be placed on the event. The wagers may be made at the racetracks, at off-track betting establishments, or using the system 10 of the subject invention.

Totalizators 18 generally generate wagering odds in real time based on wagers being placed and may include wagering pools. Totalizators 18 provide racing data including information on the current races at racetracks, the number of races associated with each racetrack, win, place, and show odds and pool totals for each horse or other runner, and exacta, trifecta, and quinella payoff predictions and pool totals for every possible combination of runners. Totalizators 18 may further provide race results, such as the order-of-finish list for at least the first three positions and payoff values versus a standard wager amount for win, place, and show, for each runner in the finish list. Payoff values may be provided for winning complex wager types such as exacta, trifecta, quinella, and daily double. The payoff values may be accompanied by a synopsis of the associated finish list. Totalizators 18 may also provide program information of the type typically provided in printed racing programs. Such program information may include early odds, early scratches, race descriptions (including the distance of each race and the race surface—grass, dirt, artificial turf, etc.), allowed class ratings (based on a fixed ratio of external criteria, purse value (payoff to winning runner), allowed age range of runners, and the allowed number of wins and starts for each runner.

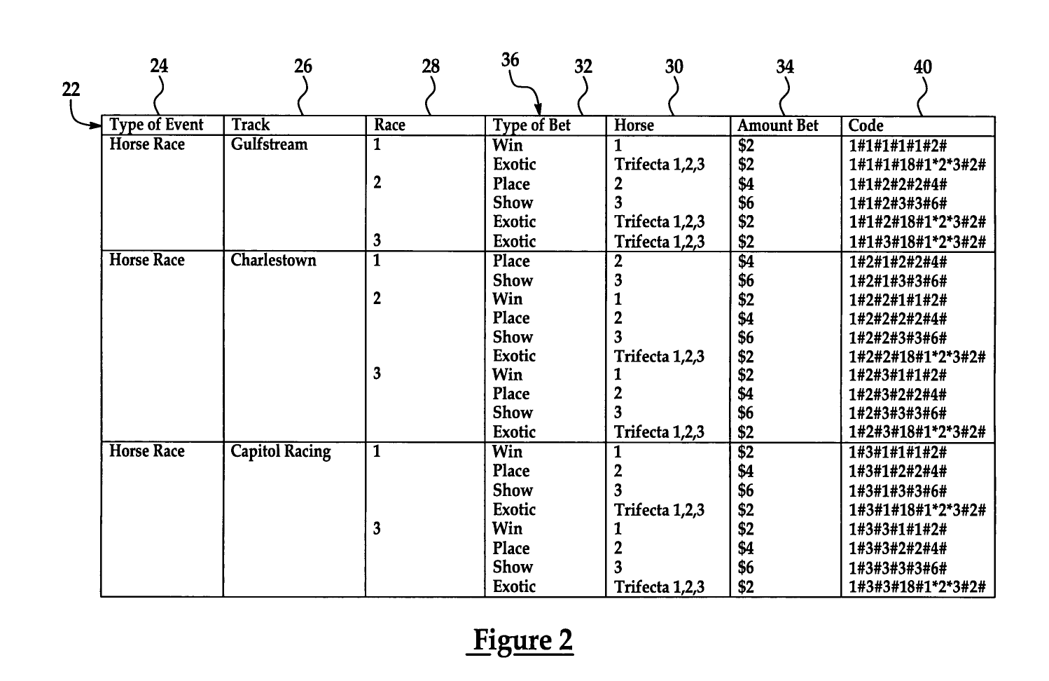

The system 10 further includes a database 36 in communication with the web server 16 and a graphical user interface 38 (GUI). If multiple IVR systems 20 and totalizators 18 are used, then a plurality of databases 36 dedicated to each may be used. However, a single database 36 may host multiple IVR systems 20. Referring to FIG. 2, the database 36 stores the codes for the IVR system 20 and generates a string of codes 40 corresponding to the wager. The database 36 may include the criteria 22 used to establish the wager, such as the type of event 24, track 26, race number 28, type of wager 32, horse 30, and amount of bet.

In FIG. 2, the string of code 40 is shown for each bet established. The type of event 24 is illustrated as a horse race and the tracks 26 are Gulfstream, Charlestown, or Capitol Racing. For illustrative purposes only, the code for choosing the event as a horse race may be “1” and the code for the tracks is “1”, “2”, and “3”, respectively. The system 10 may require that each code be separated by a specific symbol, such as the pound sign or an asterisk. Multiple races may be run at each of the tracks and each race may have the code corresponding to the race number.

The type of wager 32, as described above, also has the specific codes, such as “1” for win, “2” for place, “3” for show, and “18” for trifecta. Next, the horse may be selected based upon the participant number 30 and the amount to be bet is selected. Once each criterion 22 is selected, the string of code 40 is generated. For example, if the wager is for a horse race at Charlestown, race number 2, horse number 2 to place for $4, the string of code 40 may be 1#2#2#2#2#4#.

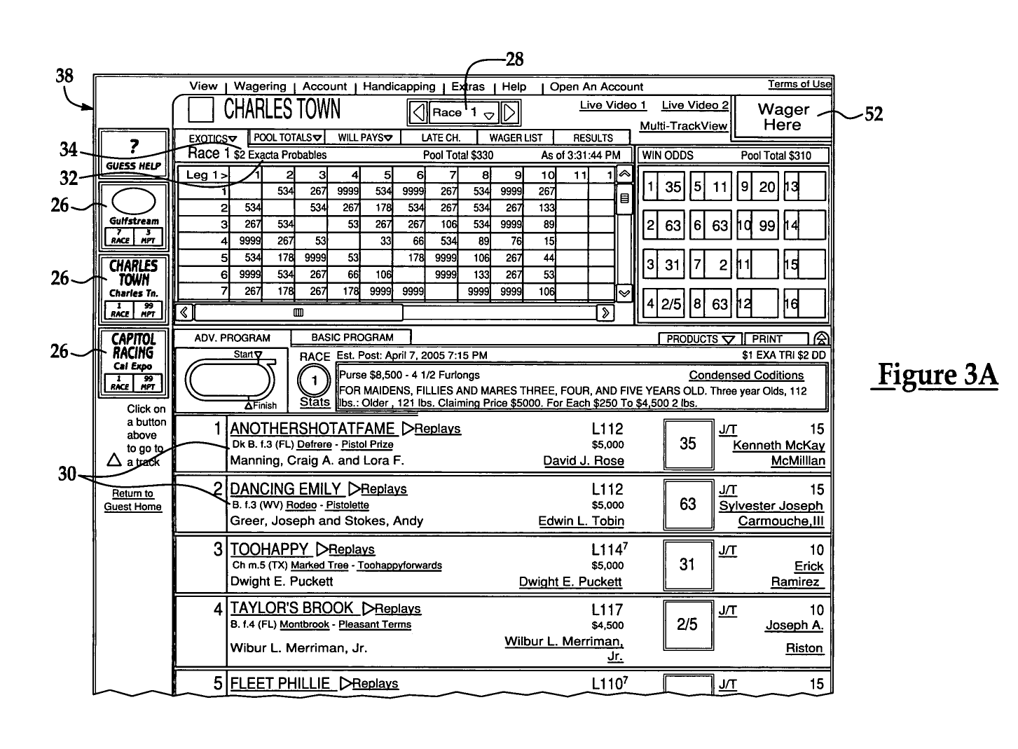

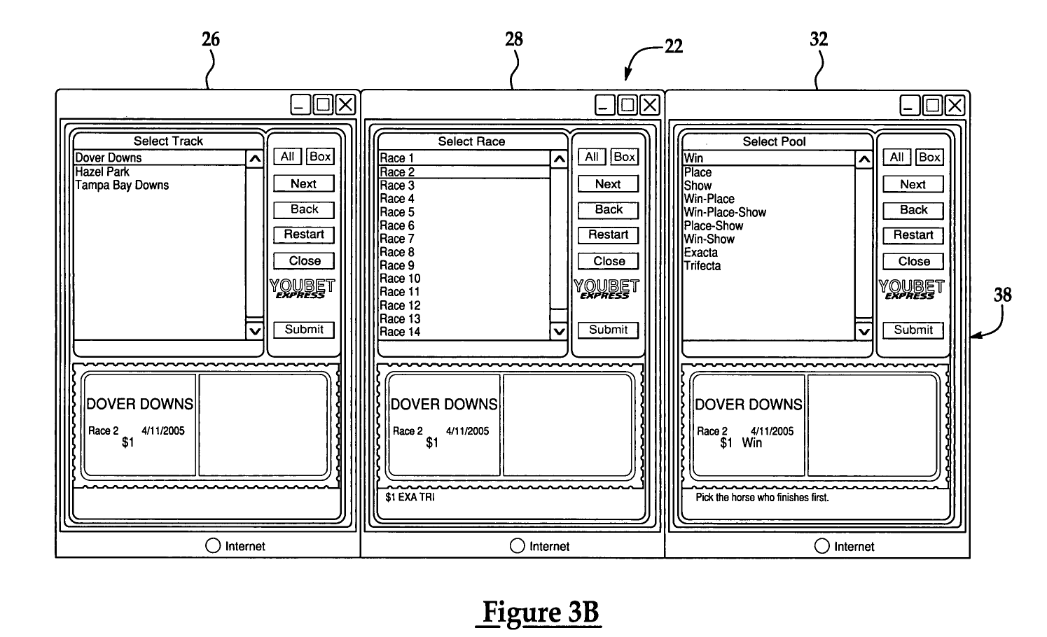

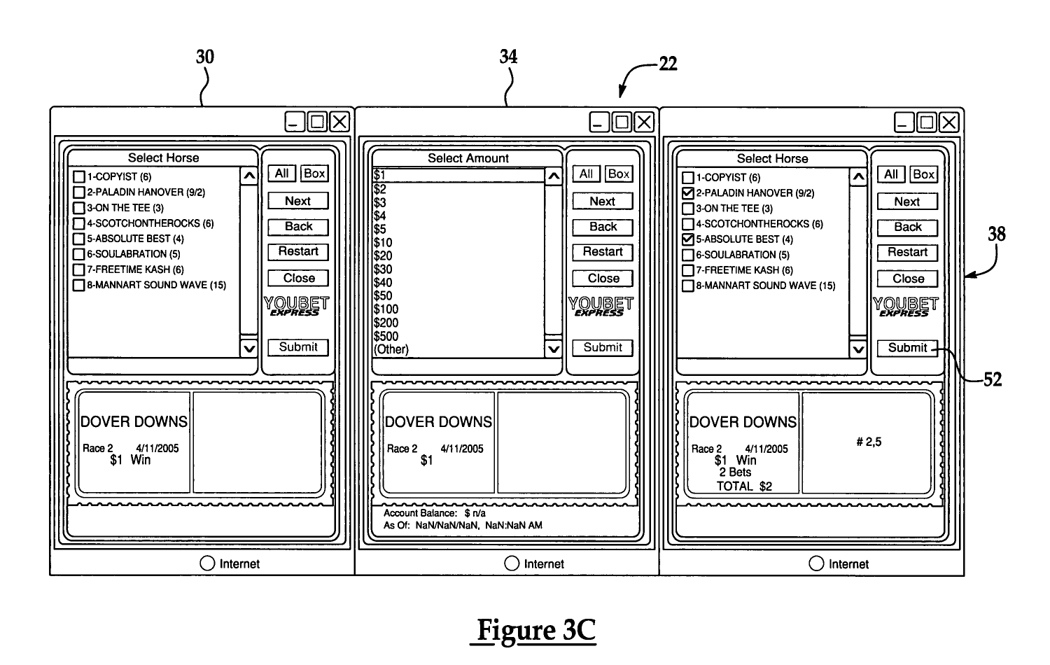

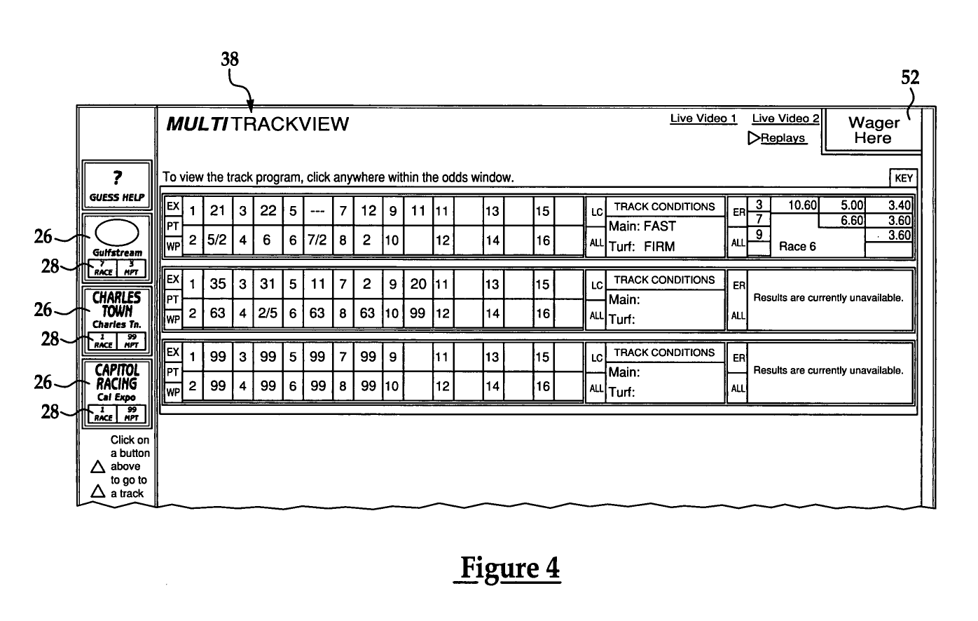

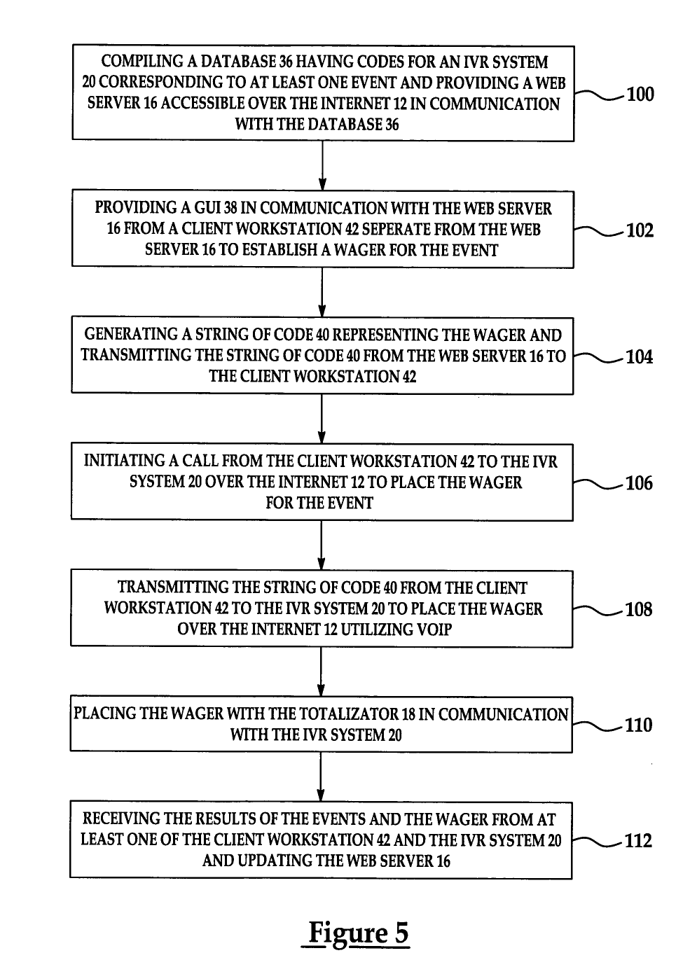

Referring to FIGS. 3A, 3B, 3C and 4, a graphical representation of the GUI 38 is illustrated. More specifically, FIG. 3A illustrates the GUI 38 showing one race at Charlestown and FIG. 4 illustrates the GUI 38 showing multiple tracks and at least one race occurring at each track. The GUI 38 is accessible from a client workstation 42, preferably separate from the web server 16; however, as understood by those skilled in the computer arts, the GUI 38 is operated on and hosted by the web server 16. The client workstation 42 includes any electronic device that is able to connect to the Internet 12. Examples of the client workstation 42 may include desktop computers, laptop computers, personal digital assistants (PDA), web-enabled cellular phones, kiosks, digital notebooks, and the like.

The GUI 38 allows the user to select a plurality of racetracks. The race information includes each entrant's current odds of winning the next race, the current track conditions, and the payouts for win, place, and show. The GUI 38 shows the race information for each of the plurality of races and allows the user to select the plurality of races that are to be displayed from a larger set of races. FIGS. 3B and 3C illustrate the GUI 38 having the criteria 22 to allow the user to establish the wager. From the GUI 38, the user is able to select the track 26, the race number 28, and the pool 32 for the wager. The user then selects the horse 30 and the amount to be bet 34. The GUI 38 may present the user with a graphical ticket representing the wager and then the user clicks a “submit” or “place wager” button 52 to place the wager.

After placing the wager, the GUI 38 allows the user to quickly access previous race results from any particular racetrack, which may include the winner of the race and where the other horses placed, the payouts for a win, place, and show and the payouts for the exotics. The GUI 38 also allows the user to review results from previous races at each racetrack.

Referring again to FIG. 2, based upon selections of criteria 22 made by the user, the GUI 38 establishes the wager and initiates a call from the client workstation 42 to transmit the string of code 40 to the IVR system 20. The GUI 38 further interacts with a calling program located on the client workstation 42 to place the call to the IVR system 20 for placing the wager. One type of calling program is offered by Vonage® for placing calls using VOIP.

Preferably, the call is placed using voice-over internet protocols (VOIP). It has been determined that wagers placed from the client workstation 42 using VOIP and the Internet 12 do not run afoul of the Internet 12 wagering prohibition of those select jurisdictions. Wagers placed with the subject invention are considered to be placed by phone even though the POTS 14 is not used to place the wager. In order to use VOIP, the GUI 38 transmits the string of code 40 as digital packets from the calling program to a VOIP gateway 44. As understood by those skilled in the art, the VOIP gateway 44 enables voice applications to be handled over existing data infrastructures. The GUI 38 includes an authorization sequence for establishing communication with the VOIP gateway 44 over the Internet 12. The authorization sequence ensures that the user will only be able to use VOIP for placing wager calls and prevents users from using the VOIP gateway 44 for non-wager calls.

After the VOIP gateway 44, the wager is transmitted to the IVR system 20 and then to the totalizator 18. The web server 16 is in communication with the totalizator 18 for providing the information from the totalizator 18 to the user through the GUI 38. However, the web server 16 may obtain the information that is provided by the totalizator 18 from independent sources and use such information for updating the GUI 38. Once the event is complete, results for the event are communicated back to the user. The results may be transmitted through either the client workstation 42 or the IVR system 20 to the web server 16. The results may be sent via the Internet 12, VOIP, or POTS 14. Preferably, the results are sent from the totalizator 18 over the Internet 12 to the web server 16. The results are then updated into the GUI 38 such that the user is able to view the results.

Referring back to FIG. 1, the system 10 may also include a customer account manager 46 (CAM) for managing financial activities associated with a user account for the user. Preferably, the CAM 46 is implemented in software. A risk management system 48 and a funding system 50 may also be in communication with the CAM 46 as disclosed in copending U.S. patent application Ser. No. 10/940,865 titled “SYSTEM AND METHOD FOR RELAYING RACE INFORMATION”, which is incorporated herein by reference. The risk management system 48 assists the CAM 46 in determining whether to accept a wager and the funding system 50 acts as an interface between funding agents, such as banks and other financial institutions. The funding system 50 is used by the user to deposit funds in the user account and to place the wager. Depending upon the results of the event, the user may then have winning funds deposited into the user account based upon the wager.

In operation, the subject invention provides the method of placing the wager utilizing the system 10 described above. First, the method includes the step of compiling the database 36 having codes for an IVR system 20 corresponding to at least one event and providing the web server 16 accessible over the Internet 12 in communication with the database 36 in step 100. If a plurality of IVR systems 20 having different codes are connected to the system 10, then the plurality of databases 36 are compiled having codes for the plurality of events different from one another associated with each of the IVR systems 20.

Next, in step 102, the GUI 38 is provided in communication with the web server 16 from the client workstation 42 separate from the web server 16 to establish the wager. To establish the wager, at least one criterion 22 associated with the event is selected to generate the string of code 40. As described above, each criterion 22 corresponds to the different code in the database 36. Once the criteria 22 are selected, the codes for each of the selected criterion 22 are combined to generate the string of code 40.

In step 104, the string of code 40 representing the wager is generated and transmitted from the web server 16 to the client workstation 42. The user may be unaware of the codes or the string of codes 40. It is preferred that it appears to the user that the wager is being placed directly over the Internet 12, instead of from the client workstation 42. The string of code 40 is preferably transmitted as a combination of touch tones representing the string of code 40. The touch tones may be transmitted as either one of an analog signal or the digital signal. If the analog signal is used, then the analog signal is converted to digital packets for transmission utilizing VOIP to the IVR system 20. The string of code 40 may also include the user account identifier to identify which user placed the wager.

Then, the call is initiated from the client workstation 42 to the IVR system 20 over the Internet 12 to place the wager for the event, in step 106. In order for the call to be initiated, the user actively initiates the call by selecting it from the GUI 38. For example, after the user selects the criteria 22 for establishing the wager, the user may select the “submit”, “place bet”, or “place call” button 52 from within the GUI 38. In addition to actively initiating the call, the calling program needs to be located on the client workstation 42, so the calling program is downloaded to the client workstation 42 in a first session. Thereafter, in subsequent sessions, the calling program does not need to be downloaded. The user also creates the user account to allow the user access to the GUI 38 and web server 16. The use account may be protected by well known methods, such as, but not limited to, password protection. Once the user logs into the user account, the web server 16 detects whether the calling program is present on the client workstation 42 and determines whether the calling program needs to be downloaded to the client workstation 42.

The GUI 38 also stores the authorization sequence for allowing the calling program to place the call to the VOIP gateway 44. As discussed above, the authorization code prevents users from placing non-wager calls using the system 10 of the subject invention.

In step 108, the string of code 40 is transmitted from the client workstation 42 to the IVR system 20 to place the wager over the Internet 12 utilizing VOIP. The wager is then placed with the totalizator 18 in communication with the IVR system 20 in step 110. After the event is completed, in step 112, the results of the events and the wager are received from at least one of the client workstation 42 and the IVR system 20 and updating the web server 16.

Obviously, many modifications and variations of the present invention are possible in light of the above teachings. The invention may be practiced otherwise than as specifically described within the scope of the appended claims.

What is claimed is:

1. A method of placing a wager on events, said method comprising the steps of:
compiling a database having codes for an interactive voice response system corresponding to at least one event;
providing a web server accessible over the Internet in communication with the database;
providing a graphical user interface in communication with the web server from a client workstation separate from the web server to establish a wager to be placed on the event;
generating a string of code representing the wager;
transmitting the string of code from the web server to the client workstation; and
initiating a call from the client workstation to the interactive voice response system over the Internet to place the wager for the event.

2. A method as set forth in claim 1 wherein the step of initiating the call over the Internet is further defined as utilizing voice-over internet protocols.

3. A method as set forth in claim 1 further comprising the step of transmitting the string of code from the client workstation to the interactive voice response system to place the wager.

4. A method as set forth in claim 3 further comprising the step of placing the wager with a totalizator in communication with the interactive voice response system.

5. A method as set forth in claim 3 further comprising the step of receiving results of the wager from via at least one of the client workstation and the interactive voice response system and updating the web server.

6. A method as set forth in claim 3 wherein the step of transmitting the string of code is further defined as transmitting a combination of touch tones representing the string of code to the interactive voice response system.

7. A method as set forth in claim 6 wherein the step of transmitting the touch tones is further defined as transmitting either one of an analog signal or a digital signal to the interactive voice response system.

8. A method as set forth in claim 7 wherein the step of transmitting the analog signal is further defined as converting the analog signal to digital packets for transmission utilizing voice-over internet protocols to the interactive voice response system.

9. A method as set forth in claim 6 wherein the step of transmitting the touch tones is further defined as transmitting the touch tones utilizing voice-over internet protocols to the interactive voice response system.

10. A method as set forth in claim 1 wherein the step of initiating the call is further defined as activating a calling program located on the client workstation to place the call.

11. A method as set forth in claim 10 wherein the step of activating the calling program is further defined as storing an authorization sequence for allowing the calling program to place the call to a VOIP gateway connected to the Internet.

12. A method as set forth in claim 10 further comprising the step of downloading the calling program from the web server to the client workstation during a first session.

13. A method as set forth in claim 12 further comprising the step of creating a user account to allow a user access to the graphical user interface during subsequent sessions without having to download the calling program to the client workstation having previously downloaded the calling program.

14. A method as set forth in claim 13 wherein the step of generating the string of code further includes the step of combining a user account identifier with the string of code.

15. A method as set forth in claim 1 wherein the step of compiling the database is further defined as compiling a plurality of databases for a plurality of interactive voice response systems having codes different from one another.

16. A method as set forth in claim 15 wherein the step of compiling the plurality of databases is further defined as compiling codes for a plurality of events different from one another associated with each of the interactive voice response systems.

17. A method as set forth in claim 1 wherein the step of establishing the wager is further defined as selecting at least one criterion associated with the event to generate the string of code.

18. A method as set forth in claim 17 wherein each of the criterion is further defined as corresponding to a different code in the database.

19. A method as set forth in claim 17 wherein the step of selecting at least one criterion is further defined as selecting at least one event type, event location and venue, event number, participant number, type of wager, number of wagers, and amount to wager.

20. A method as set forth in claim 19 wherein the step of generating the string of code is further defined as combining codes for each of the selected criterion to generate the string of code.

21. A method as set forth in claim 19 wherein the step of selecting the type of event is further defined as selecting the type of event from at least one of horse racing, dog racing, automobile racing, sporting events, game shows, and casino events.

22. A method as set forth in claim 20 wherein the step of selecting the location is further defined as selecting at least one track and at least one race being run at the track.

23. A system for placing a wager on events without utilizing a plain-old telephone system, said system comprising:
a web server connected to the Internet;
a database in communication with said web server storing codes for a interactive voice response system responsive to codes corresponding to at least one criterion associated with an event and generating a string of codes corresponding to a wager;
a graphical user interface accessible from a client workstation separate from said web server for communicating with said web server to establish said wager and for initiating a call from the client workstation to transmit said string of code to the interactive voice response system using voice-over internet protocols.

24. A system as set forth in claim 23 wherein said graphical user interface is further defined as interacting with a calling program located on the client workstation to place said call to the interactive voice response system for placing said wager.

25. A system as set forth in claim 24 wherein said graphical user interface is further defined as transmitting said string of code as digital packets from the calling program.

26. A system as set forth in claim 24 wherein said graphical user interface is further defined as having an authorization sequence for communication with a VOIP gateway over the Internet to transmit the string of code to the interactive voice response system.

27. A system as set forth in claim 23 wherein said graphical user interface is further defined as in communication with a totalizator to place said wager on said event.

28. A system as set forth in claim 23 further comprising a plurality of databases for a plurality of interactive voice response systems having codes different from one another.

29. A system as set forth in claim 23 wherein said event is further defined as at least one of horse racing, dog racing, automobile racing, sporting events, game shows, and casino events.
